(19) United States
(12) Patent Application Publication
(10) Pub. No.: US 2026/0305874 A1
(43) Pub. Date: Oct. 8, 2026

(54) Grill appliance with a damper assembly

(71) Applicants: Günther Zimmer, Rheinau (DE); Martin Zimmer, Rheinau (DE)

(72) Inventors: Günther Zimmer, Rheinau (DE); Martin Zimmer, Rheinau (DE)

(21) Appl. No.: 19/635,884

(22) Filed: Apr. 1, 2026

(30) Foreign Application Priority Data
Apr. 4, 2025 (DE) 10 2025 001 164.4

(51) Int. Cl. A47J 37/07; E05F 3/02; E05F 3/10

(52) U.S. Cl. CPC A47J 37/0786; E05F 3/02; E05F 3/108; E05Y 2201/224; E05Y 2201/266; E05Y 2900/30

(57) ABSTRACT

A grill appliance includes an appliance lower part that has an appliance tray and a combustion chamber arranged beneath a grill grate, and an appliance lid that is pivotable on the appliance lower part by at least one pivot joint having a horizontal pivot axis between a closed operating position and an open position over a total pivot angle. Both the appliance lid and the appliance tray are each made of a metallic material or of a metal-based composite material. A damper assembly having a total stroke is mounted on the appliance lower part and on the appliance lid. The appliance lid and/or the appliance tray are arranged so as to intersect every connecting line between the combustion chamber and the damper assembly both in the operating position and in the open position. A pivoting movement of the appliance lid is damped.

### CROSS-REFERENCE TO RELATED APPLICATION

This application claims the benefit of German Patent Application DE 10 2025 001 164.4, filed on Apr. 4, 2025, the entire contents of which is incorporated by reference.

### TECHNICAL FIELD

The application is in the field of grill appliances.

### BACKGROUND

A grill appliance is known from US 2020/0087961 A1. It has a tension spring arranged in a pivot joint, which supports the opening of an appliance lid.

### SUMMARY

The disclosure relates to a grill appliance comprising an appliance lower part that has an appliance tray and a combustion chamber arranged beneath a grill grate, and comprising an appliance lid that is pivotable on the appliance lower part by means of at least one pivot joint having a horizontal pivot axis between a closed operating position and an open position over a total pivot angle, wherein both the appliance lid and the appliance tray are each made of a metallic material or of a metal-based composite material.

The present invention is based on the problem of damping the pivoting movement of the appliance lid.

This problem is solved by the grill appliance as disclosed herein. For this purpose, a damper assembly is mounted on the appliance lower part and on the appliance lid. The appliance lid and/or the appliance tray are arranged so as to intersect every connecting line between the combustion chamber and the damper assembly both in the operating position and in the open position.

The appliance lid and the appliance lower part are pivotable relative to one another over a total pivot angle. In an operating position, the appliance lid is closed. For example, the appliance lid bears on the appliance lower part. In the open position, the appliance lid is pivoted open by at least an angle of 90 degrees. In this open position, the grill appliance can be loaded with food items to be grilled, or food items to be grilled can be removed from the grill grate. The total pivot angle between the operating position and the open position can be, for example, up to 115 degrees.

During the entire pivoting movement, the damper assembly connects the appliance lower part to the appliance lid. The damper assembly is arranged in a spatial region which, neither in the operating position nor in the open position, lies in a radiation region of a heat source arranged in the combustion chamber. This thermal radiation in the direction of the damper assembly is blocked by the appliance lower part and/or the appliance lid.

### BRIEF DESCRIPTION OF THE DRAWINGS

FIG. 1: Grill appliance in the operating position;

FIG. 2: Grill appliance with the appliance lid pivoted open by 15 degrees;

FIG. 3: Grill appliance with the appliance lid pivoted open by 45 degrees;

FIG. 4: Grill appliance in the open position;

FIG. 5: Partial section of a grill appliance;

FIG. 6: Telescopic tube unit in the end position;

FIG. 7: Longitudinal section of the telescopic tube unit from FIG. 6 in the start position;

FIG. 8: Longitudinal section of the telescopic tube unit from FIG. 6;

FIG. 9: Connection insert;

FIG. 10: Variant of a telescopic tube unit in the start position;

FIG. 11: Variant from FIG. 10 in the end position;

FIG. 12: Detail of the telescopic tube unit from FIG. 10;

FIG. 13: Grill appliance with the telescopic tube unit from FIGS. 10 and 11 in the end position;

FIG. 14: Grill appliance from FIG. 13 with the telescopic tube unit in the start position.

### DETAILED DESCRIPTION

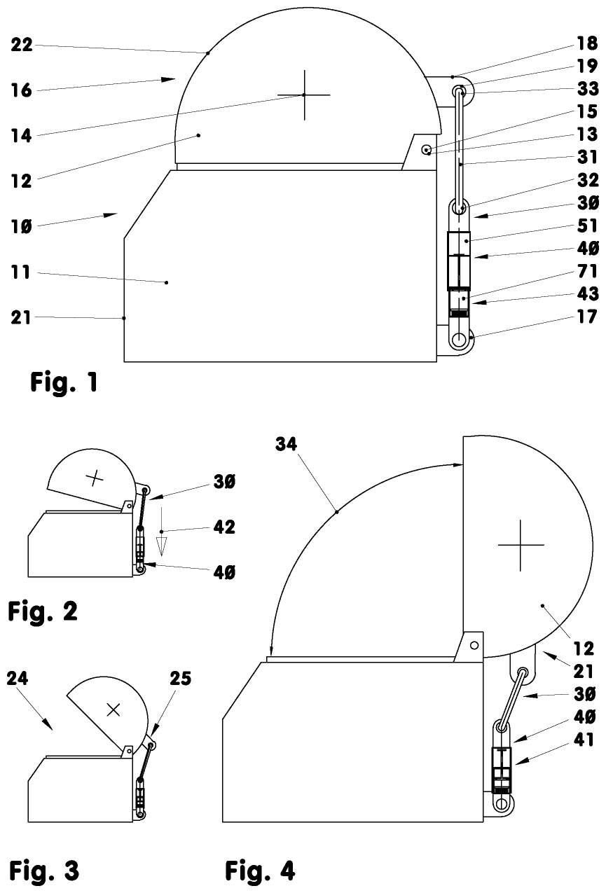

FIGS. 1-4 show a grill appliance (10) having an appliance lower part (11) and an appliance lid (12). The grill appliance (10) may be, for example, a stationary grill or a movable grill. The appliance lid (12) is pivotably mounted on the appliance lower part (11) by, for example, two pivot joints (13). The pivot axis (15) of the pivot joints (13) is oriented in a horizontal direction. In the exemplary embodiment, the appliance lower part (11) stands directly on the ground.
FIG. 1 shows the grill appliance (10) in an operating position (16). The appliance lid (12) is in a closed position. For example, it bears on the appliance lower part (11). In this exemplary embodiment, the appliance lid (12) is configured in the form of a hood. It is made, for example, of a metallic material, e.g. aluminum, an austenitic steel, cast iron, etc. The use of a metal-based composite material is also conceivable. In this case, for example, at least the inner wall of such an appliance lid (12) is made of one of the aforementioned metallic materials. The appliance lid (12) has a center of mass (14) which, in the illustration of FIG. 1, is located in space above the pivot axis (15) and offset relative to the pivot axis (15). In this illustration, the vertically oriented center-of-mass line intersects the appliance lower part (11) centrally.

A first mounting point (17) on the appliance lower part side is arranged on the appliance lower part (11), and a second mounting point (18) on the appliance lid side is arranged on the appliance lid (12). The mounting point (17) on the appliance lower part side is located, for example, on the outer side (22) of the appliance lower part (11). The mounting point (18) on the appliance lid side is located, for example, on the outer side (23) of the appliance lid (12). The mounting point (17) on the appliance lower part side can be arranged in the appliance lower part (11). Likewise, it is conceivable for the mounting point (18) on the appliance lid side to be arranged in the appliance lid (12). The mounting point (17) on the appliance lower part side and the mounting point (18) on the appliance lid side lie in a common vertical plane. This plane is oriented normal to the pivot axis (15). The two mounting points (17, 18) retain a damper assembly (30). In the exemplary embodiment, this damper assembly (30) has a telescopic tube unit (40) and a tension cable (31) fastened to the telescopic tube unit (40).

The telescopic tube unit (40) has an outer tube (51), in which a base tube (71) is guided so as to be linearly displaceable. The telescopic tube unit (40) is arranged, for example, on the appliance lower part (11) in a vertical direction. In the illustrations of FIGS. 1-4, the base tube (71) points downward. The base tube (71) is, for example, rigidly retained at the mounting point (17) on the appliance lower part side. The outer tube (51) has, in this exemplary embodiment, a top-side base (52). The tension cable (31) is fastened to this base (52) in this exemplary embodiment. This tension cable (31) is, for example, a multi-strand wire cable which carries, at its ends, in each case a thimble (32, 33). One of the thimbles (32) passes through a cable eye (53) arranged on the base (52). The other thimble (33) is retained in a second cable eye (19). This second cable eye (19) is part of the mounting point (18) on the appliance lid side.

The damper assembly (30) may be configured without a tension cable (31). In this case, pivot joints may be arranged on the outer tube (51) and on the base tube (71). For example, one of these pivot joints connects the base tube (71) to the appliance lower part (11). The other pivot joint then connects the outer tube (51) to the appliance lid (12). In this case as well, the damper assembly (30) is arranged in a vertical plane which intersects the grill appliance (10).

It is also conceivable to use a single damper instead of the illustrated telescopic tube unit (40). This damper is, for example, constructed as a cylinder-piston unit. It has a cylinder in which a damper piston carrying a piston rod is guided. The damper piston has, for example, a throttle valve and a throttle disk, such that the movement of the piston rod projecting out of the cylinder is decelerated more strongly in one stroke direction than in the opposite direction.

In the operating position (16) shown in FIG. 1, the damper assembly (30) of this exemplary embodiment has its maximum length. The telescopic tube unit (40) is extended. It is in an end position (43). The tension cable (31) is under tension.

For manual opening of the appliance lid (12), the appliance lid (12) is pivoted relative to the appliance lower part (11) about the pivot axis (15). FIG. 2 shows an unstable intermediate position in which the housing lid (12), with reference to the illustration of FIG. 1, is pivoted open, for example, by an angle of 15 degrees. In the illustration of FIG. 2, the telescopic tube unit (40) is shortened. In this case, the base tube (71) is retracted further into the outer tube (51) compared to the illustration of FIG. 1. This retraction takes place, for example, under gravity control. The retraction movement may also be assisted by a return spring. The length of the tension cable (31) remains unchanged.

In the illustration of FIG. 3, the appliance lid (12) is pivoted open from the operating position (16) by an angle of 45 degrees. The operator continues to stand on the operating side (24), which faces away from the joint side (25) of the grill appliance (10). In this unstable intermediate position, the telescopic tube unit (40) is further shortened. The base tube (71) is retracted further into the outer tube (51). The length of the tension cable (31) remains unchanged.

In FIG. 4, the grill appliance (10) is shown with the appliance lid (12) open. In this open position (21), the appliance lid (12) is pivoted open relative to the operating position (16) by an angle of, for example, 90 degrees. In the illustrated exemplary embodiment, this angle is the total pivot angle (34) of the appliance lid (12) relative to the appliance lower part (11). During pivoting open, a center-of-mass line applied at the center of mass (14) of the appliance lid (12) has passed through the pivot axis (15). The maximum pivot angle of the appliance lid (12) relative to the appliance lower part (11) may be, for example, up to 115 degrees. This total pivot angle (34) of the appliance lid (12) may be limited by a stop projecting from the appliance lower part (11), a hinge stop, etc.

In the open position (21), the appliance lid (12) is in a stable position relative to the appliance lower part (11). The center-of-mass line of the appliance lid (12) lies outside the appliance lower part (11) and outside the pivot axis (15). The base tube (71) is retracted further into the outer tube (51). The telescopic tube unit (40) has reached a start position (41). The length of the tension cable (31) remains unchanged.

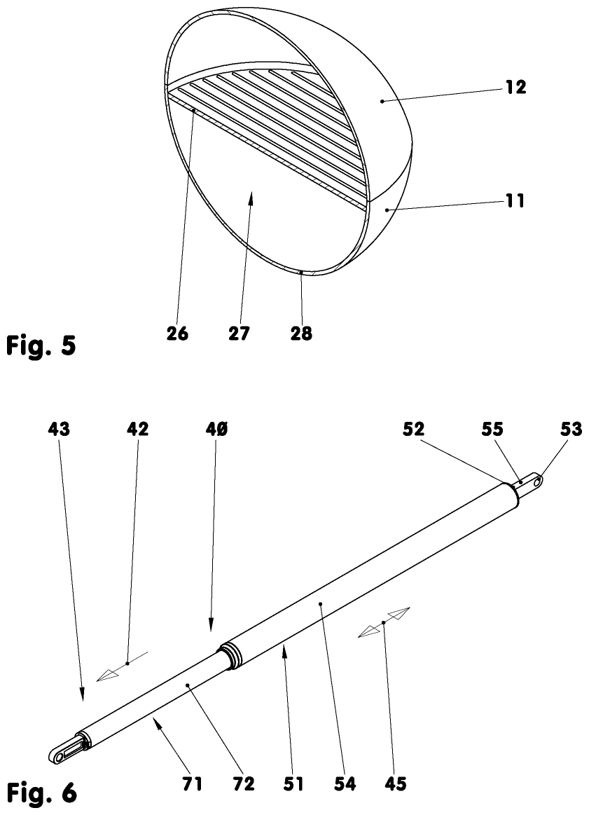

FIG. 5 shows a cross section through a grill appliance (10). The appliance lower part (11), shown here without adjustable feet or a support frame, has an appliance tray (28). The appliance tray (28) is made, for example, of the same materials as the appliance lid (12). The heat source of the grill appliance (10) is arranged in this appliance tray (28). This heat source is, for example, charcoal, a gas burner, electrical heating conductors, etc.

In an upper region of the appliance tray (28), the latter carries a grill grate (26). The food items to be grilled are placed on the grill grate (26). After heating, the food items to be grilled are removed from the grill grate (26) for consumption. The space bounded by the grill grate (26) and the appliance tray (28) is referred to below as the combustion chamber (27). The appliance lid (12) is shown in this illustration in the operating position (16).

FIGS. 6-9 show a telescopic tube unit (40) and some of its individual components. The total length of the telescopic tube unit (40) in the retracted state is, for example, 255 millimeters. In the extended state, the total length is, for example, 40% greater than this length. The telescopic tube unit (40) has an outer tube (51) with an outer diameter of, for example, 14 millimeters. The length of the outer tube (51) is, for example, 58% of the length of the extended telescopic tube unit (40). The outer tube (51) has an outer tube section (54). This has, for example, a constant wall thickness of 0.5 millimeters and a circular annular cross section that is constant over its length. The outer tube (51) is closed at its free end by means of a connection insert (55). In this connection insert (55), the base (52) and the cable eye (53) are formed.

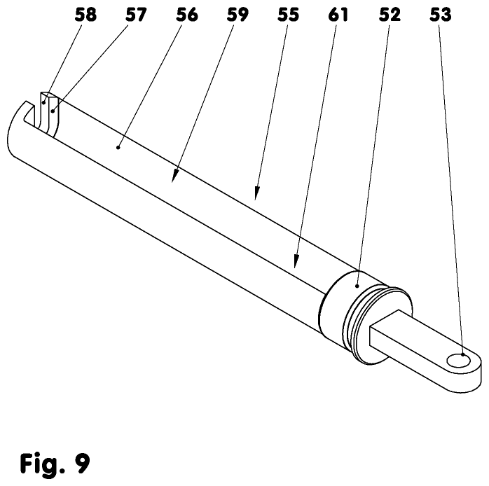

The connection insert (55), see FIG. 9, has a receiving cup (56) which is arranged in the outer tube (51). The receiving cup (56) is delimited, in the direction of the cable eye (53), by the base (52) and, in the direction of the base tube (71), by a stop wall (57). The base (52) is configured, for example, in the shape of a circular disk. The stop wall (57) has a transverse slot (58) of constant width, which adjoins an assembly opening (59). The assembly opening (59) has, in a plan view, a rectangular cross section. The length of the assembly opening (59) in a longitudinal direction (45) of the telescopic tube unit (40) corresponds to the distance between the stop wall (57) and the base (52). The width of the assembly opening (59) corresponds, for example, to the inner diameter of the receiving cup (56). The space bounded by the receiving cup (56) and the outer tube (51) is referred to below as the idle stroke space (61). The length of this idle stroke space (61) is the distance between the stop wall (57) and the base (52). For example, this length is between 20% and 35% of the length of the telescopic tube unit (40) in the retracted state. In the exemplary embodiment, the length of the idle stroke space (61) corresponds to 29% of the length of the telescopic tube unit (40) in the retracted state.

At its end facing away from the base (52), the outer tube (51) carries an annular sliding element (62). In the exemplary embodiment, this has a radial clearance of 0.4 millimeters relative to the base tube (71). The gap seal (64) thus formed seals the base tube (71) relative to the outer tube (51). Sealing by means of a sealing lip is also conceivable.

The length of the base tube (71) is, in the exemplary embodiment, 60% of the length of the outer tube (51). The base tube (71) has a base tube section (72) and a guide section (73). The outer diameter in the base tube section (72) is, for example, 71% of the diameter of the outer tube (51). The base tube section (72) has a circular cross section that is constant over its length. The wall thickness of the base tube section (72) corresponds to the wall thickness of the outer tube section (54).

At its projecting end, the base tube (71) has a compensation insert (74). A closure plug (75) is seated in the compensation insert (74). This closure plug (75) is, for example, connected to the mounting point (17) on the appliance lower part side. In the illustrated exemplary embodiment, the closure plug (75) has, for this purpose, a through bore (76).

The compensation insert (74) has an insert tube (77), which is seated in the base tube section (72) in a sealed manner. A compensation piston (78) is displaceably mounted in the insert tube (77). The compensation piston (78) bears against the inner wall of the insert tube (77) with an annular compensation piston seal (79). A compensation spring (81) supports the compensation piston (78) on the closure plug (75).

At the end of the base tube (71) facing away from the compensation insert (74), a cylinder head insert (82) is seated. The cylinder head insert (82) has an outer surface (83) configured as a sliding surface. In the assembled telescopic tube unit (40), during a relative movement of the base tube (71) and the outer tube (51) with respect to one another, the outer surface (83) slides along the inner wall of the outer tube (51). It thereby forms the guide section (73) of the base tube (71).

The cylinder head insert (82) has a longitudinal passage (84), in which a sealing ring (85) is seated. The sealing ring (85) surrounds a piston rod (86) and is fixed by means of a retaining ring (87) fixed in the cylinder head insert (82). The piston rod (86) is connected to a damper piston (88) which is displaceably mounted in the base tube (71). In the exemplary embodiment, the piston rod (86) has a diameter of three millimeters. A piston rod head (96) of the piston rod (86) projects into the idle stroke space (61). This piston rod head (96) has, for example, an annular disk (89). The thickness of the annular disk (89) in the longitudinal direction (45) corresponds, for example, to the diameter of the piston rod (86).

The damper piston (88) has throttle bores (91) oriented in the longitudinal direction (45). A valve disk (92) of the damper piston (88), which is displaceable on the piston rod (86), can vary the cross sections of the throttle bores (91) depending on the stroke direction. In the exemplary embodiment, the valve disk (92) is arranged on the side of the damper piston (88) facing the cylinder head insert (82). The interior space (93) of the base tube (71) is filled with, for example, a hydraulic fluid. The use of a gas in the interior space (93) of the base tube (71) is also conceivable.

In the base tube (71), the damper piston (88) separates a displacement space (94) from a compensation space (95). The maximum stroke of the damper piston (88) is the maximum usable displacement path of the damper piston (88) between a retracted position and an extended position of the piston rod (86).

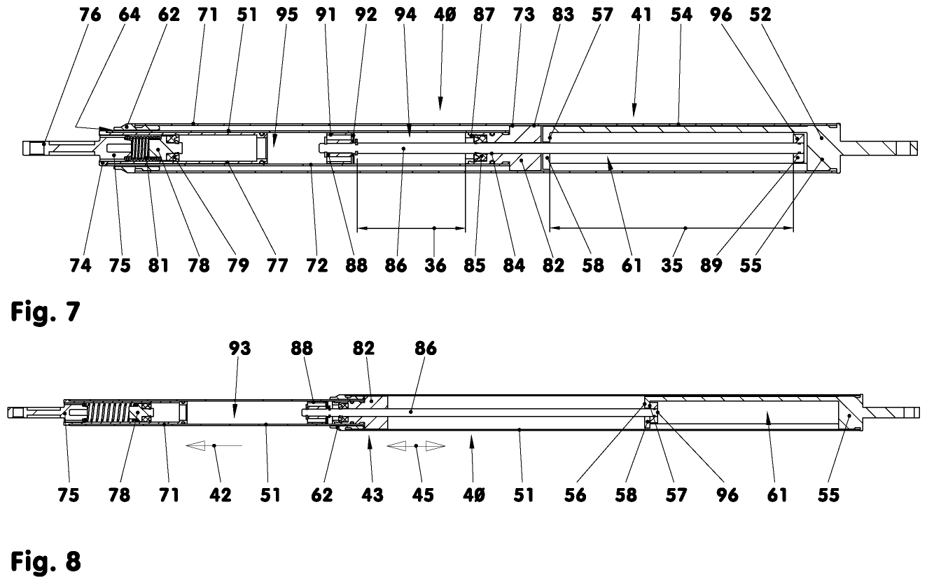

With the appliance lid (12) open, see FIG. 4, the telescopic tube unit (40) is retracted. The appliance tray (28) and the appliance lid (12) protect the damper assembly (30) from the thermal radiation from the combustion chamber (27). If appropriate, the mounting points (17, 18) may be configured to be thermally insulated. In this way, the damper assembly (30) is also protected against heat conduction. For example, in the illustrated start position (41), the base tube (71) and the outer tube (51) are arranged relative to one another as shown in FIG. 7. The base tube (71) is retracted into the outer tube (51). In this illustration, the base tube (71) bears, with the cylinder head insert (82), against the connection insert (55) of the outer tube (51). The piston rod (86) with the annular disk (89) has a small distance from the base (52). In the base tube (71), the damper piston (88) is located in a central position in the longitudinal direction (45).

From the start position (41), the damper assembly (30) is adjustable over a total stroke into an end position (43). The said total stroke is composed of an idle stroke region (35) and a damping stroke region (36).

During closing of the appliance lid (12), see FIGS. 3 and 2, the appliance lid (12) pulls the outer tube (51) upward relative to the base tube (71) by the tension cable (31). In this process, the base tube (71) is extended relative to the outer tube (51) in the working stroke direction (42). The length of the telescopic tube unit (40) is increased. During this extension, the damper piston (88) initially remains stationary relative to the base tube (71). For example, no fluid is displaced between the displacement space (94) and the compensation space (95).

During extension of the outer tube (51) relative to the base tube (71), the connection insert (55) with the receiving cup (56) is moved along. The distance of the receiving cup (56) from the cylinder head insert (82) is increased. The idle stroke space (61) is displaced relative to the stationary piston rod (86), such that the stop wall (57) approaches the piston rod (86). The tension cable (31) and the appliance lid (12) experience no resistance during this idle stroke of the telescopic tube unit (40). The movement of the base tube (71) and the outer tube (51) relative to one another is not influenced by the damper piston (88).

Upon further closing of the appliance lid (12), the idle stroke of the telescopic tube unit (40) is terminated once the stop wall (57) strikes against the piston rod (86). The piston rod head (96) is displaced relative to the stop wall (57) by the idle stroke region (35). During this pivoting, the appliance lid (12) is pivoted relative to the appliance lower part (11) over an idle pivot angle region of the total pivot angle (34). In the idle pivot angle region, the position of the damper piston (88) relative to the base tube (71) remains unchanged. The center of mass (14) of the appliance lid (12) now lies above the appliance lower part (11).

If the appliance lid (12) is closed further in the direction of the operating position (16) shown in FIG. 1, the tension cable (31) continues to pull the outer tube (51) upward. By means of the stop wall (57), the outer tube (51) pulls the piston rod (86) upward relative to the, for example, fixed base tube (71). The base tube (71) is extended further in the working stroke direction (42) relative to the outer tube (51). During the displacement movement in the working stroke direction (42), the length of the telescopic tube unit (40) is increased. The piston rod (86) carries the damper piston (88) along relative to the base tube (71). In this process, the valve disk (92) bears against the outlets of the throttle bores (91). Oil from the displacement space (94) is throttled into the compensation space (95). The further extension movement of the piston rod (86)—and thus the closing movement of the appliance lid (12)—is decelerated. In this damping stroke region (36) of the damper assembly (30), the appliance lid (12) is pivoted relative to the appliance lower part (11) in a damping pivot angle region. Even if the appliance lid (12) is now let go, it lowers only slowly onto the appliance lower part (11). The telescopic tube unit (40) is extended further.

FIGS. 1 and 8 show the extended telescopic tube unit (40) in the end position (43). The piston rod (86) bears against the stop wall (57). The damper piston (88) bears, for example, against the cylinder head insert (82) or has a small distance from it. In this exemplary embodiment, the idle stroke region (35) amounts to 70% of the total stroke of the telescopic tube unit (40). The damping stroke region (36) amounts to 30% of the total stroke. Thus, the idle stroke region (35) is more than twice as large as the damping stroke region (36). Also in the illustrated operating position (16), the appliance tray (28) and/or the appliance lid (12) block the direct path of thermal radiation from the combustion chamber (27) in the direction of the damper assembly (30).

Upon renewed opening of the appliance lid (12), the tension cable (31) is relieved. The outer tube (51) moves downward under gravity control. In this process, the piston rod (86), which is free of force, initially remains largely stationary. The base (52) approaches the piston rod (86). As soon as the piston rod (86) has been displaced by the idle stroke region (35), the base (52), during further lowering of the outer tube (51), pushes the piston rod (86) downward. The piston rod (86) displaces the damper piston (88) downward counter to the damping direction. The fluid flowing from the compensation space (95) into the displacement space (94) lifts the valve disk (92), such that no or only slight deceleration occurs during this movement. The telescopic tube unit (40) is retracted until it has reached, for example, the retracted length of the start position (41) shown in FIG. 7.

A return spring may be used to assist the return movement. This is, for example, configured as a compression spring and is arranged on the piston rod (86) between the damper piston (88) and the cylinder head insert (82).

The total stroke, the idle stroke region (35), and the damping stroke region (36) may be adjustable. For this purpose, for example, the length of the piston rod (86) may be adjustable. It is also conceivable, for example, to use compensation plates on the stop wall (57) and/or on the base (52), which limit the utilized stroke. Adjustable stroke stops, for example for setting the total stroke, are also conceivable. A second, additional damper may also be arranged in the idle stroke space (61). In this case, for example, a cylinder base of the second damper forms the stop wall (57).

The structure and the arrangement of the telescopic tube unit (40) prevent the ingress of dirt and enable effective cleaning. The piston rod (86) is not subjected to transverse forces in any operating state.

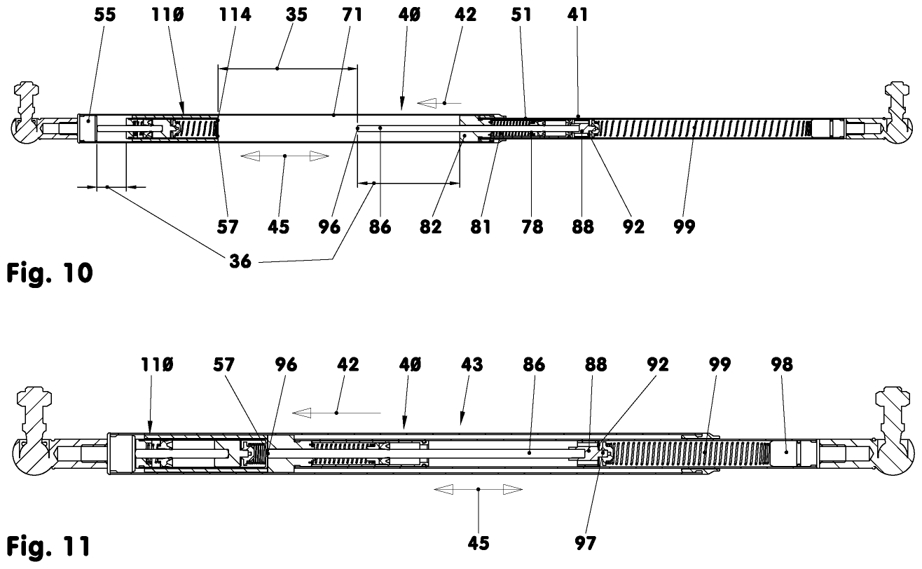

FIGS. 10-12 show a telescopic tube unit (40) in which, during a movement of the outer tube (51) and the base tube (71) relative to one another in the working stroke direction (42), the length of the telescopic tube unit (40) is reduced. The base tube (71) and the outer tube (51) have, for example, in each case the same diameters as the corresponding components of the first exemplary embodiment. The length of the telescopic tube unit (40) of this exemplary embodiment in the extended state is, for example, 24% greater than the length of the telescopic tube unit (40) shown in FIGS. 1 and 8. The total stroke of the telescopic tube unit (40) shown in FIGS. 10-12 is 30% greater than the stroke of the telescopic tube unit (40) shown in the first exemplary embodiment.

A damper piston (88) is arranged in the base tube (71). A piston rod (86) is fastened to the damper piston (88). A spring-loaded compensation piston (78) is arranged in a compensation space (95) between a cylinder head insert (82) and the damper piston (88). The piston rod (86) passes through the compensation space (95) and the cylinder head insert (82) and projects into the idle stroke space (61) formed in the outer tube (51). The piston rod head (96) has a stop surface. The stroke of the damper piston (88), which is a portion of the damping stroke region (36), amounts, for example, to 38% of the total stroke of the telescopic tube unit (40).

The damper piston (88) has throttle bores (91) oriented in the longitudinal direction (45) and a valve disk (92) that is displaceable in the longitudinal direction. The valve disk (92) is arranged in the displacement space (94). The damper piston (88) functions analogously to the damper piston (88) described in connection with the first exemplary embodiment.

A return spring (99) is supported on a piston pin (97) and on a base tube base (98). This return spring (99) is configured as a compression spring and loads the damper piston (88) in the direction of the outer tube (51).

The telescopic tube unit (40) of this exemplary embodiment has an auxiliary damper (110). This is arranged, for example, in a damper sleeve (63), which is displaceably mounted in the outer tube (51). The auxiliary damper (110) is configured as a cylinder-piston unit. It has an auxiliary damping cylinder (111), in which an auxiliary damping piston (112) with an auxiliary piston rod (113) fastened to the auxiliary damping piston (112) is mounted. The auxiliary damping cylinder (111) has a closed cylinder base (114). This cylinder base (114) faces in the direction of the base tube (71). An auxiliary cylinder head (115) is oriented in the direction of the connection insert (55) of the outer tube (51). The auxiliary piston rod (113) of the auxiliary damper (110) passes through the auxiliary cylinder head (115). In the illustrations of FIGS. 10-12, the auxiliary piston rod (113) bears against the connection insert (55).

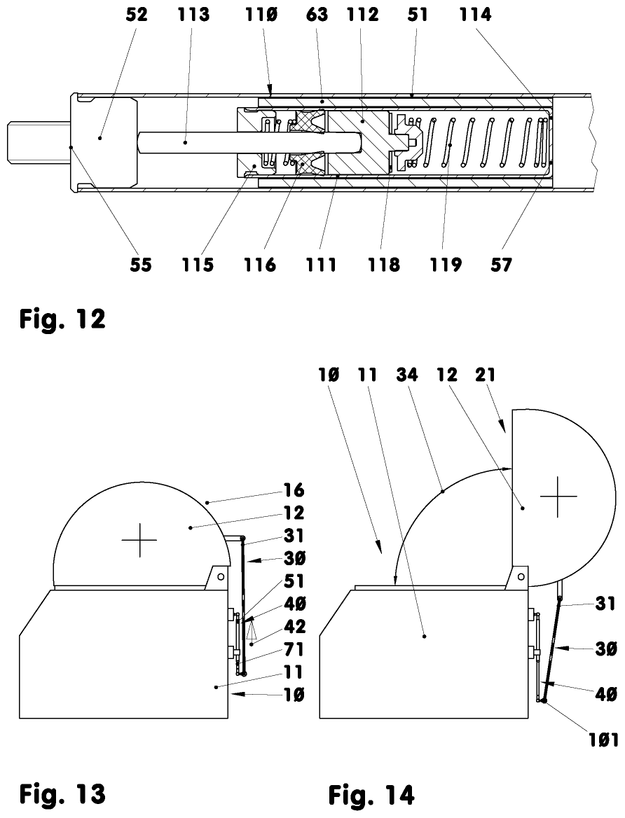

In the exemplary embodiment, the auxiliary damper (110) is configured as a hydraulic damper. It is also conceivable to use a gas damper as the auxiliary damper (110). The auxiliary damper (110), shown enlarged in FIG. 12, has a spring-loaded auxiliary compensation sealing element (116). The auxiliary damping piston (112) has a valve disk (118), which is arranged on the side facing away from the auxiliary piston rod (113). An auxiliary return spring (119) is arranged between the auxiliary damping piston (112) and the cylinder base (114). The stroke of the auxiliary damper (110) amounts, in the exemplary embodiment, to 30% of the stroke of the damper piston (88) arranged in the base tube (71). This stroke is a further portion of the damping stroke region (36) of this exemplary embodiment.

FIGS. 13 and 14 show an application example of the telescopic tube unit (40) shown in FIGS. 10-12. The telescopic tube unit (40) is, for example, part of a damper assembly (30) which delays the closing of an appliance lid (12). The appliance lower part (11), the appliance lid (12), and the pivot joints (13) are constructed, for example, as described in connection with FIGS. 1-4. The damper assembly (30) is arranged on the outer side (22) of the appliance lower part (11) and on the outer side (23) of the appliance lid (12), protected from thermal radiation. The telescopic tube unit (40) is, for example, fastened to the appliance lower part (11) in a dual mounting point (17) on the appliance lower part side. The mounting point (17) on the appliance lower part side holds, for example, the outer tube (51) in a fixed position, from which the base tube (71) projects downward. This mounting point (17) may be configured to be insulating against heat conduction. The free end of the base tube (71) carries a cable eye (101). This cable eye (101) is connected by means of a tension cable (31) to a cable eye (19) arranged on the appliance lid (12). The mounting point (18) on the appliance lid side may also impede heat transfer. At least when the appliance lid (12) is closed, the tension cable (31) is under tension. In this operating position (16) of the appliance lid (12), the telescopic tube unit (40) is in its end position (43). It has its shortest length, see FIGS. 11 and 13.

During opening of the appliance lid (12) from the operating position (16), the tension cable (31) is relieved. The base tube (71) is displaced downward with almost no resistance. The piston rod (86) and the auxiliary piston rod (113) are relieved. At the same time, the return spring (99) and the auxiliary return spring (119) are relieved. The piston rod (86) is extended relative to the base tube (71). The auxiliary piston rod (113) is extended relative to the auxiliary damping cylinder (111). In this process, the damper sleeve (63), together with the auxiliary damper (110), is displaced in the outer tube (51) in the direction of the base tube (71). In the open position (21) of the appliance lid (12) shown in FIG. 14, the telescopic tube unit (40) has, for example, reached the maximum length shown in FIG. 10. It is now in the start position (41).

During closing of the appliance lid (12) from the open position (21), the tension cable (31) is carried along by means of the cable eye (19) of the appliance lid (12). The tension cable (31) pulls the base tube (71) upward relative to the fixed outer tube (51). The base tube (71) is retracted into the outer tube (51) in the working stroke direction (42) of this exemplary embodiment. The retraction of the base tube (71) initially takes place largely without resistance until the piston rod (86) strikes against the cylinder base (114) of the auxiliary damper (110). In this exemplary embodiment, the cylinder base (114) forms the stop wall (57). The appliance lid (12) pivots relative to the appliance lower part (11) in an idle pivot angle region adjoining the open position (21), which is assigned to an idle stroke region (35) of the telescopic tube unit (40).

During further closing of the appliance lid (12), the base tube (71) is retracted further into the outer tube (51). In the telescopic tube unit (40), both dampers are retracted either sequentially or simultaneously. The retraction movement is decelerated by the two compression dampers, such that the appliance lid (12) lowers slowly onto the appliance lower part (11). A damping pivot angle region of the total pivot angle (34), adjoining the operating position (16), is assigned to a damping stroke region (36) of the telescopic tube unit (40). With the appliance lid (12) closed, the telescopic tube unit (40) has, for example, reached the end position (43) shown in FIG. 11.

In the telescopic tube unit (40) shown in FIGS. 10-14 as well, the total stroke, the idle stroke region, and/or the damping stroke region may be adjustable. IT IS CONCEIVABLE TO COMBINE THE INDIVIDUAL EXEMPLARY EMBODIMENTS WITH ONE ANOTHER.

### REFERENCE NUMERALS

10 grill appliance
11 appliance lower part
12 appliance lid
13 pivot joints
14 center of mass
15 pivot axis
16 operating position
17 mounting point on the appliance lower part side
18 mounting point on the appliance lid side
19 cable eye
21 open position of (10, 12)
22 outer side of (11)
23 outer side of (12)
24 operating side
25 joint side
26 grill grate
27 combustion chamber
28 appliance tray
30 damper assembly
31 tension cable
32 thimble
33 thimble
34 total pivot angle
35 idle stroke region
36 damping stroke region
40 telescopic tube unit
41 start position
42 working stroke direction
43 end position
45 longitudinal direction of (40)
51 outer tube
52 base
53 cable eye
54 outer tube section
55 connection insert
56 receiving cup
57 stop wall
58 transverse slot
59 assembly opening
61 idle stroke space
62 annular sliding element
63 damper sleeve
64 gap seal
71 base tube
72 base tube section
73 guide section
74 compensation insert
75 closure plug
76 through bore
77 insert tube
78 compensation piston
79 compensation piston seal
81 compensation spring
82 cylinder head insert
83 outer surface
84 longitudinal passage in (82)
85 sealing ring
86 piston rod
87 retaining ring
88 damper piston
89 annular disk
91 throttle bores
92 valve disk
93 interior space of (71)
94 displacement space
95 compensation space
96 piston rod head
97 piston pin
98 base tube base
99 return spring
101 cable eye
110 auxiliary damper
111 auxiliary damping cylinder
112 auxiliary damping piston
113 auxiliary piston rod
114 cylinder base
115 auxiliary cylinder head
116 cylinder head seal
118 valve disk
119 auxiliary return spring

What is claimed is:

1. A grill appliance (10), comprising:
an appliance lower part (11), including
an appliance tray (28),
a grill grate (26), and
a combustion chamber (27) arranged beneath the grill grate (26);
an appliance lid (12) pivotable on the appliance lower part (11) by at least one pivot joint (13) having a horizontal pivot axis (15) between a closed operating position (16) and an open position (21) over a total pivot angle (34);
a damper assembly (30) is mounted on the appliance lower part (11) and on the appliance lid (12),
wherein both the appliance lid (12) and the appliance tray (28) are each made of a metallic material or of a metal-based composite material,
wherein the appliance lid (12) and/or the appliance tray (28) are arranged so as to intersect every connecting line between the combustion chamber (27) and the damper assembly (30) both in the operating position (16) and in the open position (21).

2. The grill appliance (10) of claim 1,
wherein the damper assembly (30) is arranged in a region of a joint side (25) of the grill appliance (10) facing away from an operating side (24) of the grill appliance (10).

3. The grill appliance (10) of claim 1,
wherein the damper assembly (30) has a total stroke which is composed of an idle stroke region (35) and a damping stroke region (36),
wherein the idle stroke region (35) and the damping stroke region (36) divide the total pivot angle (34) of the appliance lid (12), during closing of the appliance lid (12) in the direction of the operating position (16), into an idle pivot angle region associated with the idle stroke region (35) and a damping pivot angle region associated with the damping stroke region (36) and
wherein the idle pivot angle region adjoins the open position (21) and the damping pivot angle region adjoins the operating position (16).

4. The grill appliance (10) of claim 3,
wherein the idle stroke region (35) is at least twice as large as the damping stroke region (36).

5. The grill appliance (10) of claim 1,
wherein the damper assembly (30) is arranged in a vertical plane oriented normal to the pivot axis (15).

6. The grill appliance (10) of claim 1,
wherein the damper assembly (30) comprises a telescopic tube unit (40).

7. The grill appliance (10) of claim 6,
wherein the telescopic tube unit (40) has an outer tube (51) and a base tube (71) which is guided in the outer tube (51) in a longitudinal direction (45) from a start position (41) in a working stroke direction (42) into an end position (43) and back,
wherein a damper piston (88) connected to a piston rod (86) is displaceably mounted in the base tube (71),
wherein the piston rod (86) projects into an idle stroke space (61) formed in the outer tube (51) and delimited by at least one stop wall (57),
wherein, in the start position (41), the piston rod (86) is spaced apart from the stop wall (57),
wherein, in the end position (43), the piston rod (86) bears against the stop wall (57) and
wherein, during closing of the appliance lid (12) in the direction of the operating position (16), the outer tube (51) and the base tube (71) are displaced relative to one another from the start position (41) in the working stroke direction (42), wherein the piston rod (86) strikes against the stop wall (57), and wherein, upon further closing of the appliance lid (12), the piston rod (86) displaces the damper piston (88), which damps the said displacement movement directed in the working stroke direction (42), relative to the base tube (71).

8. The grill appliance (10) of claim 1,
wherein the damper assembly (30) comprises a tension cable (31) which is connected to the appliance lid (12).

9. The grill appliance (10) of claim 6,
wherein the telescopic tube unit (40) comprises an auxiliary damper (110) mounted in the outer tube (51) and having a cylinder base (114) forming the stop wall (57).

10. The grill appliance (10) of claim 7,
wherein a return spring (99) acting on the damper piston (88) is arranged in the base tube (71).
